(19) United States
(12) Patent Application Publication
(10) Pub. No.: US 2004/0199457 A1
(43) Pub. Date: Oct. 7, 2004

(54) Method for online mortgage shopping

(76) Inventor: Edward Joseph Dombroski, Fairfax, VA (US)

Correspondence Address: THE PARALLAX CORPORATION, 3011 CEDAR LANE, FAIRFAX, VA, 22031, US

(21) Appl. No.: 10/390,535

(22) Filed: Mar. 17, 2003

(51) Int. Cl. G06F 17/60

(52) U.S. Cl. 705/38; 705/26

(57) ABSTRACT

The invention relates generally to a method and system by which mortgage customers can shop for mortgage product rates via an Internet process. The invention allows a mortgage customer to share mortgage rate data received from mortgage lenders with other mortgage customers thereby providing comprehensive coverage of the available mortgage products offered over the Internet.

### BRIEF SUMMARY OF THE INVENTION

The Internet is fertile ground for the mortgage industry. Its potential to allow lenders to reach a large customer base and the fact that mortgage sites deal in the exchange of financial information which requires no inventory or shipping overhead has lead to a rapid growth in both the number and type of online mortgage sites.

The potential of online mortgage shopping is blunted by the fragmented nature of the mortgage industry presence on the Internet as described in the background section. The proposed system seeks to solve this problem by using a different model by which mortgage product data can be collected and presented to online customers. By allowing customers to share the rate data they obtain from a request to a particular lender with all other customers using the site, the proposed system seeks to maximize the coverage of lenders at a single site.

In order for customers to share rate data, the system uses a process to estimate what is the current rate for a given mortgage product given an actual rate received by a customer at some past time. This idea of presenting rate estimates as opposed to actual rates is a key concept for the system.

The intention of the system is to sacrifice some accuracy in rate data in order to extend the number of lender products that can be presented to a customer. As such, the system's intended use is to be a ‘first cut’ that allows the customer to focus his attention on a subset of the vast number of lenders with whom he may have interest in doing business.

### BRIEF DESCRIPTION OF THE SEVERAL VIEWS OF THE DRAWINGS

The invention may be implemented in certain parts or in collection of parts. A preferred embodiment of the invention will be described in detail and illustrated in the included drawings where:

FIG. 1 is a block diagram flowchart showing the use of the invention through a website by a mortgage customer.

FIG. 2 is a block diagram flowchart showing the use of the invention through a website by a mortgage broker or mortgage lender.

### DETAILED DESCRIPTION OF THE INVENTION

The detailed description will be elaborated by reference to the included drawings. This elaboration is done for the purpose of illustrating the preferred embodiment and not to limit the possible embodiment of the invention. The description begins by examining the use of the website embodiment by a mortgage customer who is looking for the best rate obtainable for a given mortgage product of interest.

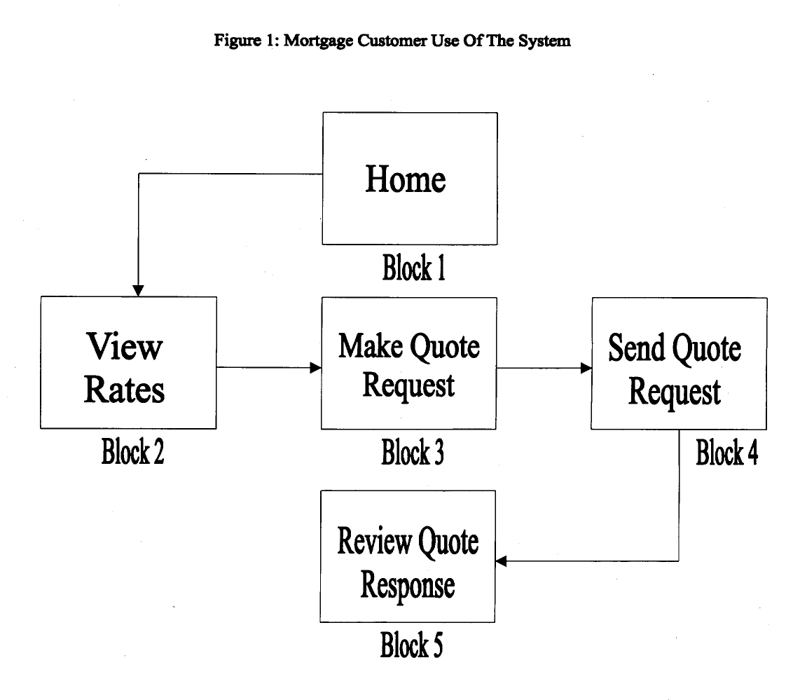

FIG. 1 describes how a mortgage customer uses the website embodiment to shop for a mortgage product. It is assumed that the customer has a fairly clear idea of: the type of mortgage product of interest, the amount of the loan, an estimate of the subject property value and an estimate of the customer's monthly income. Beginning at FIG. 1 Block 1, the customer has a variety of choices. The customer can proceed to Block 2 to get a quick overview of available rates, proceed to Block 3 to submit a quote request to a group of lenders selected by the customer, or proceed to Block 5 to review lender quote responses to previously submitted quote requests. The most likely of these choices is to first proceed to Block 2 and get an overview of rates for a given mortgage product.

Block 2 View Rates allows the customer to quickly define the minimum set of parameters for defining a mortgage product. This minimum set is selected by the customer and is comprised of: subject property state, number of units in the property, loan amount, loan type (conventional or VHA), and the product type (e.g. 30 year fixed rate, 15 year adjustable, etc.). Once selected, the system retrieves mortgage quotes from a database for a set of lenders whose parameter set matches the customer input. For each lender, four rates are displayed: the most recent actual rate registered by the lender along with the date/time that the rate was received, and three estimated rates. The three estimated rates are current rate estimates for the lender based on total points paid of 0, 1, and 2 points.

The concept of rate estimates is a core concept for the invention and will be explained by way of contrast with existing mortgage rate shopping systems. Most systems that allow customers to shop for mortgage rates rely on lenders who subscribe to those sites to update their rates on a regular, often daily basis. Rates presented at these sites are usually accurate to within one day since that is the frequency that most lenders will perform rate updates. The information model employed by these sites is one in which the lenders produce the rate data and the customer consumes the rate data. This model is also the major reason that many mortgage sites have relatively poor coverage of the total number of lenders who sell a particular mortgage product and are licensed in a particular state. There are simply too many lenders and the process is too laborious for any one site to represent more than a small number of available lenders.

In contrast, the invention uses an information model in which rate data sent by a lender to the customer for a specific customer quote request is stored both in a personal data area for the customer's use and in a system wide database for use by all customers. While the lender has the option to update rate information as often as desired, the main lender interface with the system is to answer specific quote requests from specific customers. To the lender, each quote request is essentially a sales lead and by responding the lender hopes to win the customer's business. In addition to storage in a personal data area for the customer's review, the system collects quote responses in a database along with a time tag for when the response was received. The intent is to allow customers to indirectly share the mortgage rates they receive via lender responses with all mortgage customers who use the system. When another customer requests current rate information for the same type product, these time tagged rates for past quote responses are translated into a current rate estimate for display to the new customer. For any given product type, a single lender quote response is enough for the system to continue to supply customers with current estimated rates indefinitely. Because a lender must only answer a single customer's request in order to be carried indefinitely by the system for review by all customers, the system's coverage of available mortgage lenders is extensive and grows quickly. The system is careful to explain to the customer, which rates are actual and which rates are estimates. While rate estimates tend to be quite accurate, the intent is that the system sacrifices some rate accuracy in the interests of greatly expanded coverage of available mortgage lenders.

In order to translate a rate received in the past into a current rate estimate, the system tracks 30 year fixed rate mortgage product data for a fixed number of randomly selected lenders. This is done independently of any customer quote request or lender quote response and is stored in a database on a daily basis. Its purpose is to provide the system with an index for use in calculating estimated rates.

The calculation of the system's rate index for a given day is done by taking: (1) The mean of lender products' rates sampled on the given day for a 30 year fixed rate mortgage at 0 points and (2) A rate approximation derived by applying a fourth degree least squares approximating polynomial solution to the means collected for the last ten days of index rate data. Finally, the maximum of the index value for (1) and (2) is taken as the given day's rate index value.

When a quote response with an actual rate is received for a customer, the system stores the rate, a time tag of when the response was received (T1), and a difference (D) between the response rate and the current system rate index (I). When the system needs to calculate an estimated rate for some later time (T2), it first selects the most recent actual rate for the selected product type for a given lender. The estimated rate (ER) at time T2 is then: ER=(I at T2)+D. That is, the estimated rate is equal to the system index rate at time T2 plus the rate difference D calculated above. This estimated rate is the system's best approximation to what a rate received in the past is equal to at the present time. The method is the system's means to allow customers receiving quote responses at different times to synchronize the rates they receive with other customers thereby allowing customers to share rate information.

Continuing at Block 2 (View Rates), the display of estimated rates at 0, 1, and 2 points is significant because there will typically be multiple lender rates displayed at the same time. Displaying the estimated rate at standard points amounts makes it easy for the customer to quickly compare lenders. The customer also has the option to enter any points amount of their choosing and the system will re-calculate all estimated rates for this new points amount. The estimated rate defined in [0020] is a rate estimate for zero points. The display of lenders rates in Block 2 is sorted from lowest rate to highest rate. Rate estimates for non-zero points amounts are calculated as follows: Rate at P points=(Rate at 0 points)+PointSlope*(Number of Points). The term ‘PointSlope’ is an estimation of how the lender's rate changes as a function of the number of points paid by the borrower. In order to calculate the PointSlope, the system considers two scenarios. (1) If the system has data for a given lender product based on at least two quote responses (R1 rate at P1 points and R2 rate at P2 points) then the PointSlope=(R2−R1)/(P2−P1). (2) If the system has insufficient data to calculate the PointSlope, a PointSlopeAverage function is used instead to derive the PointSlope. The PointSlopeAverage function is derived by random sampling rate data from a large number of lenders for both 15 year and 30 year fixed rate products. The PointSlopeAverage function performs simple linear interpolation using rate and point data averages for the 15 and 30-year terms of the sample set. When a specific PointSlope is needed for a specific lender product, the product term is passed to the PointSlopeAverage function. The function returns an estimate of the industry average PointSlope for that product term.

Continuing at Block 3 (Make Quote Request), the customer decides that some of the rates presented in Block 2 (View Rates) are of interest and wishes to contact a set of lenders to inquire about mortgage rates specific to the customer's needs. The system asks the customer to enter a few pieces of additional data not obtained in Block 2: name and monthly income and gives the opportunity for the customer to ask a set of to be selected lenders a question pertinent to the customer's lending situation. Customer data transmittal over the Internet is protected via SSL encryption for any interaction that involves the customer name and monthly income. Once the quote request is defined, the system will then retrieve and display lender rates as defined by the customer's product interests in a manner similar to Block 2 (View Rates). The customer will then have the option to select one or more of the displayed lenders.

Upon selecting a set of lenders, the system proceeds to Block 4 (Send Quote Request). The customer may review the quote request to be sent as well as the set of lenders to which the request will be sent. Quote responses sent by the lenders are viewed by the customer in a personal data area set up by the system for each customer. To facilitate this, new users are asked to create a login profile and returning users are asked to log in prior to the system's sending the set of quote requests. After log in, the system sends the quote requests via email to the set of selected lenders. In addition, the system may send the requests to some additional lenders not selected by the customer. These additional lenders are selected at random from a list of all possible lenders that match the customer's quote request. An alternate and future method would be to select lenders using a weighted average scheme where the additional lender is selected based on 1) the lender is a preferred lender and 2) the system does not have current rate information for a lender and needs to update its rate data for that lender.

Continuing at Block 5 (Review Quote Response) implies the customer has returned to the website at some later time to review the lenders' responses to an earlier generated quote request(s). All responses are maintained in a data area that is personal for each customer. Customer data areas are kept secure using a userid and password login that is required prior to access to a customer's quote responses. Userid parameters that appear in the customer's web browser URL window are secured by using an encryption scheme, which insures that no customer can modify the userid to gain access to any other user's data area.

After customer login, lender responses in the form of 1) rate quotes matching the customer request, 2) responses to any customer questions contained in the request, and 3) lender contact information in the form of lender website links and lender contact phone numbers. At this point the customer's interaction with the system ends and the customer would pursue loan origination with a chosen lender by contacting the lender directly.

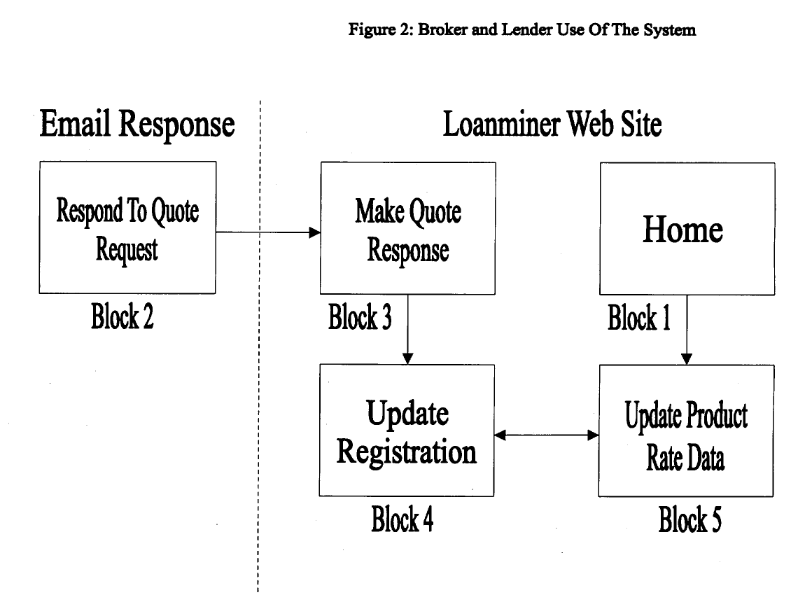

FIG. 2 describes lender interaction with the system. While most lenders who use the system have websites to represent their mortgage firms, the system can process any lender that has 1) an active domain name and 2) a valid email address. The system maintains two points of entry for the lender. One is the home page referenced in Block 1 (Home), which is simply accessed using the site URL, and the other is through direct response to a customer quote request, referenced in Block 2 (Respond To Email Request).

Beginning at Block 1 (Home), the lender may login to their previously initiated account in a manner similar to user login done in [0024]. Login provides the system with a lenderid that is encrypted whenever it is carried as a browser URL window parameter to ensure that no lender can access any other lender's account. After logging in, a lender may proceed to any of the lender functions represented in Block 4 (Update Registration) or Block 5 (Update Product Data).

Block 2 (Respond To Quote Request) represents the action of a lender responding to a customer quote request issued in [0023]. Following a link in the email will take the lender to Block 3 (Make Quote Response). To respond to a customer quote, the lender enters the product rate data requested by the customer and answers any customer question contained in the request. The system will then determine whether the lender is already registered with the system or is a new lender to the system. If the lender is new, the lender will be directed to register their mortgage firm via Block 4 (Update Registration) and enter product rate data via Block 5 (Update Product Rate Data).

Block 4 (Update Registration) provides the means for the lender to enter or update contact information for the lender's company. Such contact information such as lender address, lender URL, and lender email address allows the system to keep track of changes in the lender's physical or online contact data.

Block 5 (Update Product Rate Data) provides the means for the lender to update product rate data that is outside the scope of the response to an individual customer's quote request. Lenders may update as many product rates as they wish and may update product rate data as often as they want. If the lender has updated rate data on the day that a customer requests a matching product for this lender, the rate provided by the lender will be used. If the lender rate data is not current, then a rate estimate [0020] will be used to generate rate data displayed to the customer. This gives the lender the flexibility of updating rate data as often as desired but not necessarily on a consistent daily basis.

In summary, the development of the mortgage industry on the Internet is at an early stage. While the Internet offers potential savings for customers and lenders, this potential is only beginning to be realized. One reason for a shortfall is the fragmented nature of the mortgage industry on the Internet. While some lenders have comprehensive sites that provide a wealth of product data to customers, many lenders are just beginning to invest the resources needed to do business online. This often means that the customer faces the same problem that is a characteristic of much enterprise on the Internet—how to gather information in a coherent manner over all products that may be of interest. This invention focuses on using the Internet's strongest resource—a community of users with a common interest—to provide the means for mortgage customers to achieve the goal of finding the best mortgage product that suits their needs.

This invention has been described in detail with reference to its specific embodiment. It shall be understood that these illustrations are by way of example and not meant to limit the invention.

1. What is claimed is an Internet based process which allows mortgage customers to shop for mortgage product rates by: (a) submitting product parameters and personal information which defines the set of mortgage products in which they have interest; (b) reviewing both estimated and actual mortgages rates via a database maintained by the system; (c) creating a Quote Request based on the parameter set defined in (a) which is sent to a set of lenders both selected by the customer and the system; (d) reviewing lender responses to the Quote Requests defined in (b) in a personal customer database maintained by the system; (e) selecting lenders for contact by the customer in order to begin the mortgage loan origination process.

2. The process of claim 1, which further comprises (a) allowing mortgage customers to share the rate data they receive from mortgage lenders with other mortgage customers.

3. The process of claim 1, which further comprises (a) calculating an estimated mortgage rate based on combining actual mortgage rates collected over a period of time into a single rate estimation of a mortgage product rate at the current time.

4. The process of claim 1 which further comprises (a) calculating an estimated mortgage rate based on standard total discount and origination points amounts selected by the system and customized total discount and origination points selected by the mortgage customer.
